(19) United States
(12) Patent Application Publication
(10) Pub. No.: US 2014/0256286 A1
(43) Pub. Date: Sep. 11, 2014

(54) Intelligent Protocol Selection

(71) Applicant: MICROSOFT CORPORATION, Redmond, WA (US)

(72) Inventor: Sandeep Rangarajan, Seattle, WA (US)

(73) Assignee: Microsoft Corporation, Redmond, WA (US)

(21) Appl. No.: 13/789,822

(22) Filed: Mar. 8, 2013

(51) Int. Cl. H04W 12/08

(52) U.S. Cl. CPC H04W 12/08
USPC 455/410

(57) ABSTRACT

Example apparatus and methods concern intelligent protocol selection to facilitate more efficiently establishing secure network connections from known locations. One example method determines that a mobile device is seeking to make a connection to a secure resource from a location through a network and then acquires identifying information associated with the mobile device, the location, or the secure resource. If preferred connection information related to the identifying information is available to the mobile device, then the connection will be made using the preferred connection information. If preferred connection information related to the identifying information is not available, then the connection will be made using discovered protocol information. Once the connection is made, information about the protocols used to make the connection may be recorded or updated to influence the future establishment of secure connections by a similar device in a similar situation.

### BACKGROUND

Establishing a secure network connection from a mobile device (e.g., laptop, cellular phone) through a secure gateway may involve multiple steps and multiple protocols. A first step may involve identifying an access point. Once an access point has been identified, then a connection to the Internet may be established through that access point. The Internet is a public network that may be insecure. Therefore, establishing the secure network connection may include agreeing on a tunneling protocol, authentication method, encryption protocol, or other protocols to help protect the connection through the secure gateway to a secure resource.

Different locations from which a mobile device may attempt to connect to a secure gateway may only support specific protocols. For example, a user may frequent a coffee shop and, while at the coffee shop, may wish to establish a virtual private network into their enterprise. However, based on the configuration in the coffee shop, the user may only be able to connect using the secure socket layer (SSL) protocol since that is the only port available at the coffee shop. Even if SSL is the only protocol available, conventionally, the user's device may initially attempt to use Internet Key Exchange (IKE) and Internet Protocol Security (IPSEC) over the User Datagram Protocol (UDP) and then, after failing, fall back through other protocols before arriving at the protocol supported in the coffee shop. This iterative fallback procedure may produce undesirable delays for the user each time it is run, which may occur each time the user tries to connect, even from the same location (e.g., coffee shop) on the same day. The same case may arise if a user uses a DTLS-based (UDP) protocol initially and then falls back to TLS (TCP).

Devices on the Internet, including computers and mobile phones, may be assigned an Internet Protocol (IP) address that is used for identification and location addressing purposes. The IP address is used to facilitate communications with other devices. IP version 4 (IPv4) used 32 bit addresses, which were soon seen to be insufficient, and thus IP version 6 (IPv6) uses 128 bit addresses. Both IPv4 and IPv6 are communication protocols that route traffic across the Internet. IPv4 and IPv6 are connectionless protocols for use on a packet-switched link layer network (e.g., Ethernet). Returning to the coffee shop, both the mobile device and the access point in the coffee shop will have IP addresses. Additionally, the access point may be associated with a service set identifier (SSID), a cell identifier (CID), or other network name or identifier. An SSID is the name of a wireless local area network (WLAN). Wireless devices on a WLAN use the same SSID to communicate with each other. A wireless access point (WAP) may broadcast its SSID or a mobile device may manually enter the SSID. A CID, also known as a Cell ID, is a unique number used to identify a base transceiver station (BTS) or section of a BTS within a location area code (LAC). The information (e.g., SSID, CID, network name, network identifier) may be used as part of the protocol selection algorithm to tie geo-location as a discriminator in the selecting the optimal protocol.

Once the IP addresses involved in the desired connection are known, and once the SSID/CID are known, at least the participants in the desired secure connection are known. However, much work is still required before the secure connection can be established. For example, a decision may need to be made on protocols associated with authentication, encryption, tunneling, and other actions. The protocols that may be considered include, for example, IKE, SSL, DTLS, IPSEC, HTTPS, proprietary protocols, and others. IKE is a protocol used to set up a security association (SA) over the IPSEC security suite. IPSEC is a protocol suite for securing IP traffic by authenticating and encrypting each IP packet of a communication session. DTLS provides a datagram-based secure connection built on top of UDP using stream ciphers. SSL is a cryptographic protocol that provides communication security over the Internet. HTTPS is a layer-7 (OSI model) protocol that provides secure connectivity over the HTTP constructs typically used by the web. With so many protocols to choose from, a mobile device may be configured with a rigid hierarchy that controls the order in which protocols are tried. Cycling through this hierarchy in an iterative way to find the appropriate set of protocols for a mobile device that is attempting to establish a secure communication to a secured resource through a particular gateway from a particular location may introduce significant and undesirable delays into establishing a mobile connection.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

Example apparatus and methods concern using a more intelligent approach to selecting protocols for establishing a secure communication to a secured resource through a particular gateway from a particular location using a mobile device. Instead of blindly cycling through a pre-established hierarchy, example apparatus and methods may rely on previous information acquired about similar connections made at the location. The previous information may be acquired individually (e.g., by the mobile device) or collectively (e.g., from other devices). Users connect from a variety of remote locations, and the network setup at these remote, unmanaged networks, both WiFi and cellular, can have a significant impact on the end-user experience when authenticating and establishing secure connectivity to resources. Secure access solutions support the ability to authenticate and tunnel over a range of protocols. Conventionally, intelligence about which protocols are used by certain devices in certain locations to connect to certain gateways has not been acquired. Instead, the rigid hierarchy has been employed.

Example apparatus and methods may rely on previous similar connections to jump start their connections in an attempt to reduce the time spent making a desired connection. Returning once again to the coffee shop, if a mobile device has previously gone through the fallback procedure using its hierarchy to successfully make a desired secure connection, then the mobile device may be able to store information concerning the protocols that were ultimately used to establish the secure connection. For example, if the mobile device first attempted to use IKE/IPsec over UDP and failed, then succeeded after falling back to TCP, then this successful information may be recorded. In another example, a user may be in a location where there is a local HTTP proxy, and in a typical case, a mobile device will attempt IKE/IPSec, fallback to TCP, and with a proxy, will further fallback to HTTPS. In both these examples, the successful connection information may be recorded locally on the device or the mobile device may anonymously provide that information to a service located off the device (e.g., cloud service). Later, when another connection is attempted, the mobile device or other mobile devices may be able to use the recorded information or the service to acquire information about the protocols that were successfully employed. The recorded information may be tried first before the fallback through the hierarchy approach is attempted. By using information acquired either from the mobile device itself or from other mobile devices, a mobile device may be able to start with an appropriate set of protocols rather than having to repeatedly traverse the hierarchy. This may reduce the time spent to establish a connection.

Example apparatus and methods may be configured to consult a service (e.g., cloud service) for information concerning a connection to be established. A mobile device may provide information including a connection identifier (e.g., SSID, CID) and the public routable address (e.g., IPv4, IPv6) of the device(s) involved. The mobile device may also provide information about the secure resource or gateway to which a connection is desired. This information may be used as a key or fingerprint for a desired connection. The key may be used to locate a set of protocols or other information for the desired connection. The mobile device may then attempt to make the desired connection using the set of protocols first. If the connection attempt succeeds using the set of protocols, then the mobile device may provide confirmation back to the service that the set of protocols worked. If the connection attempt fails using the set of protocols, then the mobile device may cycle through its hierarchy to attempt to make the connection using a different set of protocols. The mobile device may then provide information to the service concerning the failure and the set of protocols, if any, that ultimately were used to make the connection.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates example participants in an example secure connection.

FIG. 2 illustrates an example method associated with intelligent protocol selection.

FIG. 3 illustrates an example method associated with intelligent protocol selection.

FIG. 4 illustrates an example set of services associated with intelligent protocol selection.

FIG. 5 illustrates an example apparatus configured to provide intelligent protocol selection.

FIG. 6 illustrates an example apparatus configured to provide intelligent protocol selection.

FIG. 7 illustrates an example cloud operating environment.

FIG. 8 is a system diagram depicting an exemplary mobile communication device configured to compute an objective application rating.

FIG. 9 illustrates an example client-side method associated with objective application rating.

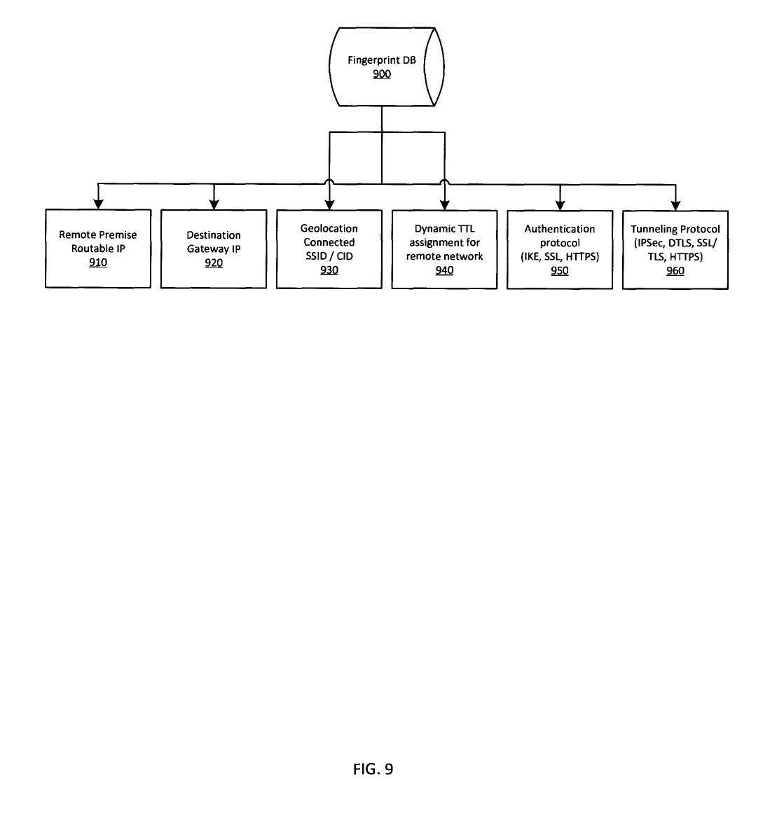

### DETAILED DESCRIPTION

Example apparatus and methods provide an intelligent protocol selection service for a mobile device. The service facilitates acquiring connection information for a mobile device at a remote location. A mobile device ought to have a head start when attempting to make a secure connection to a secured resource from a remote location. Rather than rigidly and repeatedly cycling through a hierarchy of protocol choices, a mobile device ought to be able to benefit from its prior experience in a remote location. Additionally, a remote device ought to be able to benefit from others' prior experiences in the remote location. The connection information may include, for example, authentication protocol information, encryption protocol information, tunneling protocol information, and other information. The mobile device can then use the acquired connection information first in an attempt to make a desired connection to a secured resource as quickly as possible without traversing a pre-configured hierarchy of protocol choices.

If the attempt to make the secure connection using the connection information succeeds, then the success can be reported to the service. If the attempt to make the secure connection using the connection information fails, then the failure can be reported to the service. Additionally, if the attempt to make the secure connection using the connection information fails, then the mobile device can make other attempts using other combinations of protocols, perhaps even traversing the pre-configured hierarchy of protocols. If a connection attempt ultimately succeeds, the successful connection information may be reported to the service. The service may then update its stored information. In one embodiment, the service may store information only from the mobile device. In another embodiment, the service may store information from other mobile devices that are related to the mobile device. The relationship may be, for example, that the mobile devices are all owned by the same person, by the same family, or by the same organization. The relationship may be, for example, that the mobile devices are all being used to access a particular secured resource. Other relationships may be involved. In yet another embodiment, the service may store information from unrelated mobile devices and may make this information available to any mobile device subscribed to the service. This may be a true “crowd-sourced” and “crowd-available” service.

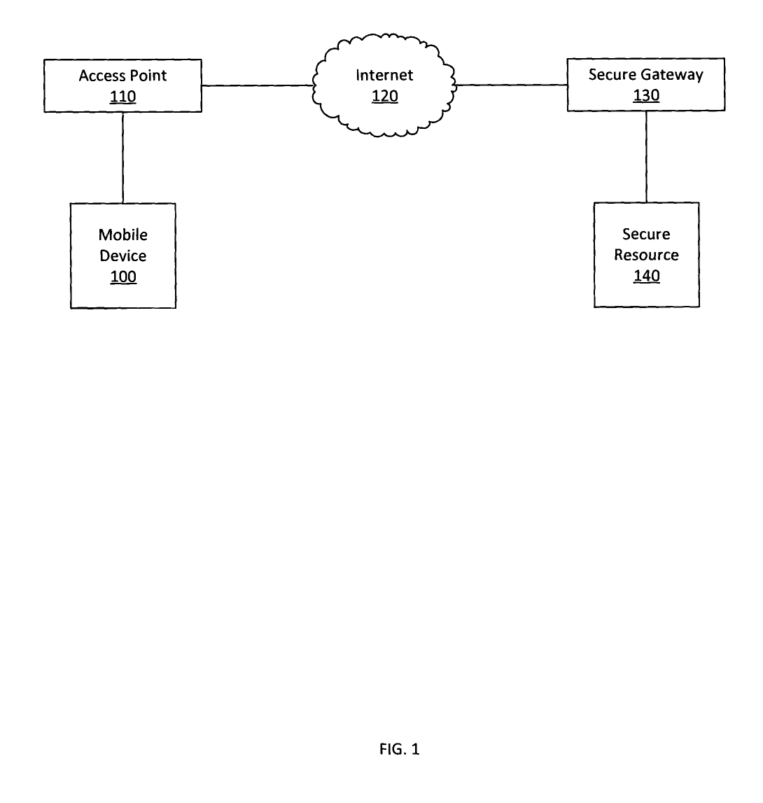

FIG. 1 illustrates example participants in an example secure connection. A mobile device 100 may seek to make a connection to a secure resource 140. The secure resource 140 may be available through and protected by, for example, a secure gateway 130. The mobile device 100 may attempt to access the secure gateway 130 through the internet 120. But first the mobile device 100 needs to establish a connection to the internet 120. Mobile device 100 may connect to the internet 120 through the access point 120.

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, system-on-a-chip (SoC), or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

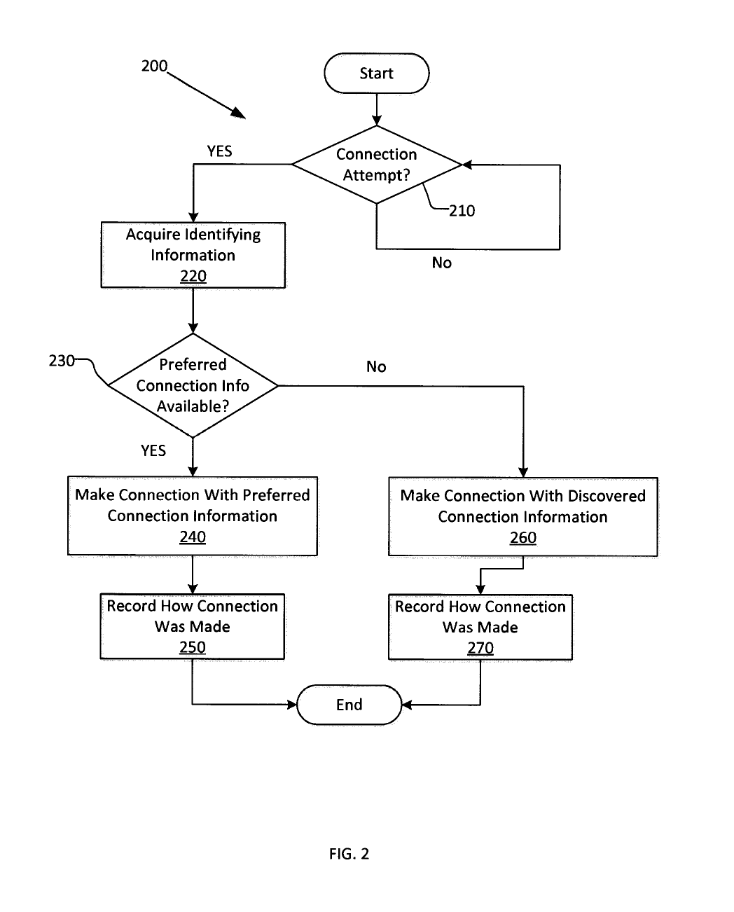

FIG. 2 illustrates an example method 200 associated with intelligent protocol selection. In different examples, method 200 may be performed on a single device, may be performed partially or completely in the cloud, may be performed on distributed co-operating devices, or may be performed other ways. In different examples, method 200 may be performed on devices including, but not limited to, a computer, a laptop computer, a tablet computer, a phone, and a smart phone.

Method 200 includes, at 210, determining whether a mobile device is seeking to make a connection to a secure resource from a location through a network. If the determination at 210 is Yes, then processing may proceed at 220, otherwise method 200 may continue to wait until a determination is made that a connection to a secure resource is being attempted.

Method 200 includes, at 220, acquiring identifying information associated with the mobile device, the location, or the secure resource. Acquiring the identifying information may include, for example, reading from a memory, receiving a network communication, receiving a wireless communication, or other action. The identifying information may include, for example, a service set identifier (SSID) or a cellular identifier (CID) that identifies the network through which the connection is going to be attempted. The identifying information may also include a publicly routable address (e.g., IP address) of the network through which the mobile device is seeking to make the connection. The identifying information may also include a routable address (e.g., IP address) of a secure gateway through which the secure resource is available. Additional data may be included in the identifying information. Identifying information is based on a fingerprint aggregating various meta-data. A fingerprint database 900 may store metadata including, but not limited to, remote premise routable IP 910, destination gateway IP 920, geo-location connected SSID/CID 930, dynamic TTL for the FP 940, authentication protocol 950, and tunneling protocol 960.

Method 200 also includes, at 230, making a determination whether preferred connection information related to the identifying information is available to the mobile device for the connection. The preferred connection information may include, for example, authentication protocol information, encryption protocol information, or tunneling protocol information. The authentication protocols may include, for example, IKE, SSL, HTTPS, proprietary, or other protocols. The encryption protocols may include, for example, Advanced Encryption Standard (AES), Data Encryption Standard (DES), Triple Data Encryption Standard (3DES), proprietary, or other approaches. The tunneling protocols may include, for example, IPsec, DTLS, SSL, HTTPS, proprietary, or other protocols.

In one example, determining that preferred connection information related to the identifying information is available to the device at 230 includes accessing a data store on the mobile device or accessing a service located off the mobile device. Accessing the data store on the mobile device may include, for example, querying a local database, making a function call to a data retrieval process, accessing memory using a pointer or address, reading a record, or other action. Accessing a service located off the mobile device may include, for example, querying a remote database, making a remote procedure call, making a network communication, or other action. In one embodiment, the determination at 230 includes determining whether the connection information has not exceeded a time to live threshold. For example, a mapping established beyond the time to live (TTL) threshold may be considered too old and thus a waste of time and resources for trying to establish a connection. If the determination at 230 is yes, then processing may continue at 240, otherwise processing may continue at 260.

Method 200 also includes, at 240, controlling the mobile device to make the connection using the preferred connection information. Controlling the mobile device to make the connection using the preferred connection information may include, for example, providing the preferred connection information to a network driver, providing the preferred connection information to a network device, providing the preferred connection information to a network stack, or other action. Establishing a network connection may include authentication, authorization, negotiations, establishing security, and other actions. In different embodiments, the preferred connection information may be provided by a service (e.g., cloud service). The service may be, for example, a public service, where multiple unrelated devices anonymously provide mappings concerning secure connections and where subscribed mobile devices may receive mappings from the service. In other embodiments, the service may be restricted to members of an enterprise, or may be private to a device or user. The service may provide preferred connection information and may also be updated with information concerning whether a connection attempted with the preferred connection information succeeded or failed.

Method 200 also includes, at 250, recording that the connection was made using the preferred connection information. In one example, recording that the connection was made using the preferred connection information includes updating the data store on the mobile device or updating the service located off the mobile device. Updating the data store on the mobile device or updating the service located off the mobile device may involve actions including, but not limited to, voting up a value associated with the preferred connection information, updating a success indicator associated with the preferred connection information, or updating a time to live value associated with the preferred connection information.

Method 200 also includes, at 260, controlling the mobile device to make the connection using a set of discovered protocol information. The set of discovered protocol information may be provided by, for example, a conventional fallback procedure that cycles through pre-configured protocol combinations until an acceptable combination is found. Controlling the mobile device to make the connection using the discovered connection information may include, for example, providing the discovered connection information to a network driver, providing the discovered connection information to a network device, providing the discovered connection information to a network stack, or other action.

Method 200 also includes, at 270, recording that the connection was made using the set of discovered protocol information. In one example, recording that the connection was made includes updating the data store on the mobile device with the set of discovered protocol information and the identifying information and relating the set of discovered protocol information to the identifying information. Relating the set of discovered protocol information to the identifying information may include, for example, establishing a mapping between the protocol information and identifying information, establishing a key:value pair where the identifying information is the key and the protocol information is the value, providing the identifying information and protocol information to a database, or other action. In another example, recording at 270 that the connection was made includes updating the service located off the mobile device with the set of discovered protocol information and the identifying information and causing the service to relate the set of discovered protocol information to the identifying information. Thus, when a connection is made, a correlation between the connection information and the protocol information may be made or refreshed on the mobile device or in the service. The information provided to the service can then be used proactively to update all subscribed mobile devices with new intelligence.

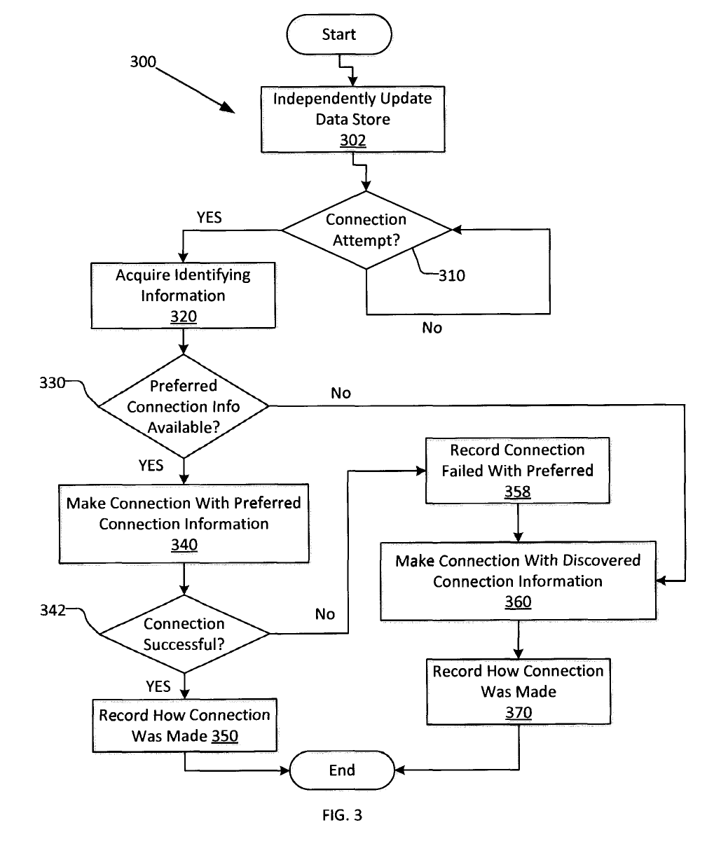

FIG. 3 illustrates an example method 300 associated with intelligent protocol selection. While method 300 includes several actions (e.g., 310, 320, 330, 340, 350, 360, 370) similar to those described in connection with method 200 (FIG. 2), method 300 also includes other actions (e.g., 302, 342).

For example, method 300 also includes, at 302, updating a data store on the mobile device with connection information received from a service external to the mobile device. Updating the data store may include writing to the data store, providing the connection information to a data store manager, providing the connection information to a data base, or other action. The update may include connection information received independent of an attempt by the mobile device to make a connection. For example, the service may periodically or under programmatic control push correlations between connection information and protocol information to mobile devices that are subscribed or otherwise available to the service.

Method 300 includes, at 342, determining whether the connection was made using the preferred connection information. If the determination is Yes, then processing continues at 350, otherwise processing continues at 358.

If the determination at 342 was that the connection was not made using the preferred connection information, method 300 continues, at 358, by recording that the connection was not made using the preferred connection information. In one embodiment, recording that the connection was not made using the preferred connection information includes updating the data store on the mobile device or updating the service located off the mobile device. Updating the data store on the mobile device may include, for example, voting down a value associated with the preferred connection information, or updating a failure indicator associated with the preferred connection information. Similarly, updating the service located off the mobile device may include voting down a value associated with the preferred connection information or updating a failure indicator associated with the preferred connection information.

Method 300 then proceeds, at 360, to control the mobile device to make the connection using the set of discovered protocol information and, at 370, to record that the connection was made using the set of discovered protocol information.

While FIGS. 2 and 3 illustrates various actions occurring in serial, it is to be appreciated that various actions illustrated in FIGS. 2 and 3 could occur substantially in parallel. By way of illustration, a first process could provide authentication services, a second process could provide discovery services, a third process could provide tunneling services, and a fourth process could provide mapping update services. While four processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage medium may store computer executable instructions that if executed by a machine (e.g., computer) cause the machine to perform methods described or claimed herein including methods 200 or 300. While executable instructions associated with the above methods are described as being stored on a computer-readable storage medium, it is to be appreciated that executable instructions associated with other example methods described or claimed herein may also be stored on a computer-readable storage medium. In different embodiments the example methods described herein may be triggered in different ways. In one embodiment, a method may be triggered manually by a user. In another example, a method may be triggered automatically.

“Computer-readable storage medium”, as used herein, refers to a medium that stores instructions or data. “Computer-readable storage medium” does not refer to propagated signals per se. A computer-readable storage medium may take forms, including, but not limited to, non-volatile media, and volatile media. Non-volatile media may include, for example, optical disks, magnetic disks, tapes, flash memory, ROM, and other media. Volatile media may include, for example, semiconductor memories, dynamic memory (e.g., dynamic random access memory (DRAM), synchronous DRAM (SDRAM), double data rate synchronous dynamic random-access memory (DDR SDRAM), and other media. Common forms of a computer-readable storage medium may include, but are not limited to, a floppy disk, a flexible disk, a hard disk, a magnetic tape, other magnetic medium, an application specific integrated circuit (ASIC), a compact disk (CD), other optical medium, a random access memory (RAM), a read only memory (ROM), a memory chip or card, a memory stick, and other media from which a computer, a processor or other electronic device can read.

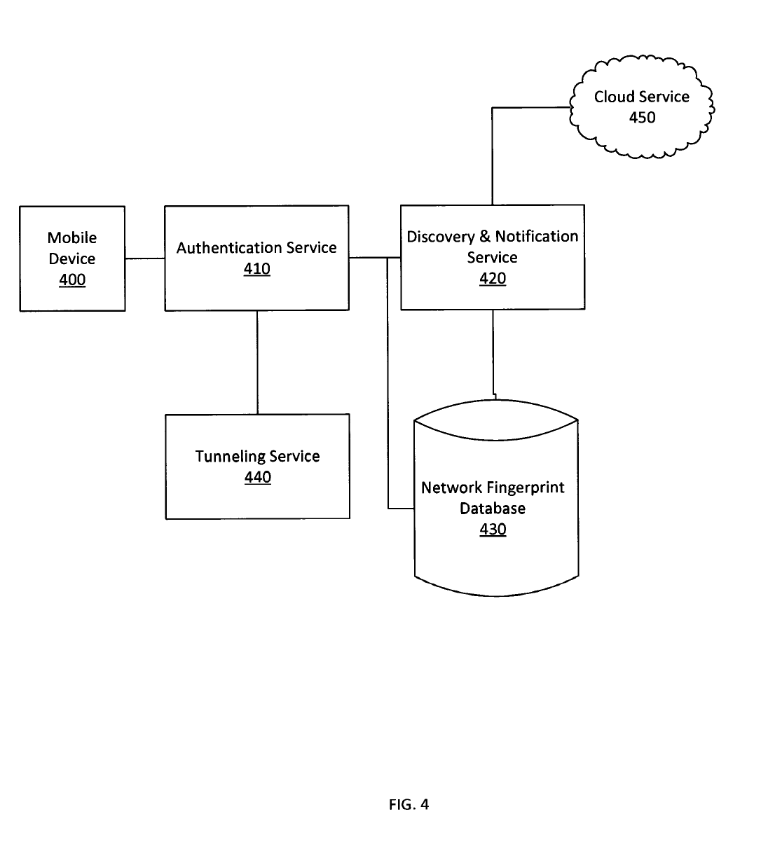

FIG. 4 illustrates an example set of services associated with intelligent protocol selection. A device 400 may seek to make a connection to a secure resource available somewhere on the Internet. The secure resource may be located behind a secure gateway. One part of establishing a connection to the internet involves authenticating the user of device 400. This authentication may be provided by an authentication service 410. The authentication service 410 may identify the user and may also acquire other information including, for example, an IP address associated with the device 400 and with a network through which the device 400 will communicate with the Internet. In one embodiment, the authentication service 410 will pass connection information (e.g., SSID/Cell ID, public IP address) to a discovery and notification service 420.

The discovery and notification service 420 may then check to see whether prior connection information (e.g., intelligence) exists. The discovery and notification service 420 may look in a network fingerprint database 430 located on the device 400 or may communicate with a cloud service 450 available in the cloud.

If prior intelligence exists, and if the time to live (TTL) for the intelligence has not expired, then the authentication service 410 and the tunneling service 440 will try to connect to the secure resource using the preferred protocols identified by the intelligence. If no intelligence exists, then a different approach for acquiring protocols may be attempted. For example, a conventional static, recursive connection scheme may be employed.

The fact that the device 400 attempts a conventional approach may indicate that a mapping is either missing or out of date or otherwise unavailable or unsuitable. Once authentication service 410 and tunneling service 440 are able to establish the secure connection, then an anonymous update may be sent to the network fingerprint database 430. The anonymous update may include a fresh TTL for the entry. Additionally, an anonymous update may be pushed to the cloud service 450 for use by other devices.

In one embodiment, the discovery and notification service 420 may periodically or under ad hoc programmatic control pull fingerprint updates or mappings from the cloud service 450. Additionally, the discovery and notification service 420 may periodically or otherwise receive fingerprint updates or mappings pushed from the cloud service 450.

In one embodiment, fingerprints or mappings may be removed from the network fingerprint database 430 upon determining that a freshness or TTL threshold has expired. Cloud service 450 may also remove fingerprints or mappings based on a freshness or TTL threshold expiring.

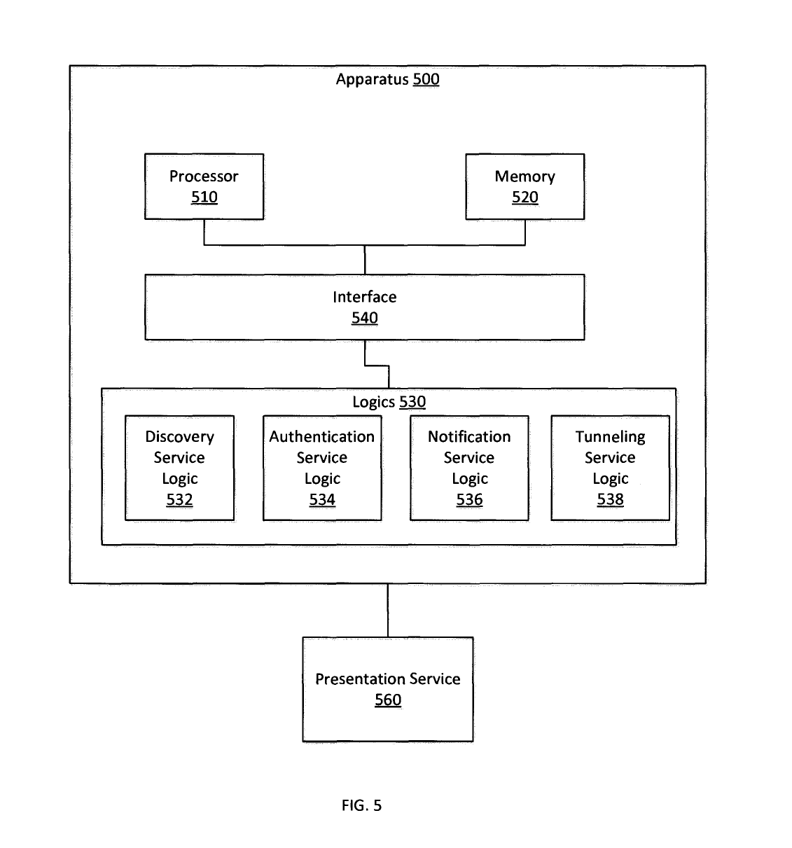

FIG. 5 illustrates an apparatus 500 that includes a processor 510, a memory 520, a set 530 of logics, and an interface 540 that connects the processor 510, the memory 520, and the set 530 of logics. The set 530 of logics may be configured to select a preferred protocol configuration for a location specific network connection between the apparatus 500 and a secure resource. The memory 520 may be configured to store network fingerprint data correlated to connection protocol data. Apparatus 500 may be, for example, a computer, a laptop computer, a tablet computer, a personal electronic device, a smart phone, or other device that can access and process data.

In one embodiment, the apparatus 500 may be a general purpose computer that has been transformed into a special purpose computer through the inclusion of the set 530 of logics. Apparatus 500 may interact with other apparatus, processes, and services through, for example, a computer network.

The set 530 of logics may include a discovery service logic 532 that is configured to maintain correlations between connection protocol data and network fingerprint data. The connection protocol data may include, but is not limited to, authentication, encryption, or tunneling information. The network fingerprint data may include, but is not limited to, network identification information and network address information.

In one embodiment, the discovery service logic 532 maintains correlations between the connection protocol data and the network fingerprint data by requesting updated correlations from a service external to the apparatus or by receiving updated correlations from the service. Thus, discovery service logic 532 may employ either a push or pull model to refresh correlations stored on apparatus 500. In one embodiment, the discovery service logic 532 is configured to selectively remove correlations between connection protocol data and network fingerprint data upon determining that a correlation has exceeded a time to live threshold. The threshold may be measured in seconds, minutes, hours, days, or other units. In one embodiment, the TTL threshold may be user configurable.

The set 530 of logics may also include an authentication service logic 534 that is configured to establish a first connection between the apparatus 500 and the network, where the first connection is identified by a network fingerprint. In one embodiment, the authentication service logic 534 may be configured to provide the network fingerprint associated with the first connection to the notification service logic 536. In one embodiment, the network fingerprint may include, but is not limited to including, a network name or identifier (e.g., SSID, Cell ID), an Internet Protocol address for an access point through which the mobile device accessed the network, and an Internet Protocol address for the secure gateway.

The set 530 of logics may also include a notification service logic 536 that is configured to selectively provide the preferred protocol configuration associated with the location specific secure connection in response to receiving the network fingerprint. In one embodiment, the notification service logic 536 may be configured to provide the preferred protocol configured from the memory or from data provided by a service external to the apparatus 500.

In one embodiment, the notification service logic 536 may be configured to report the success or failure of establishing the secure network connection using the preferred protocol configuration. Reporting the success or failure of establishing the secure network connection may change the likelihood that the notification service logic 536 will provide the preferred protocol configuration in response to receiving the network fingerprint data. For example, a successful connection may increase or maintain the likelihood that the notification service logic 536 would respond in the same way to a previously presented fingerprint. Conversely, an unsuccessful connection may decrease the likelihood that the notification service logic 536 would respond in the same way.

The set 530 of logics may also include a tunneling service logic 538 that is configured to establish and maintain the location specific secure connection using the preferred protocol configuration. Establishing and maintaining the secure connection may include, for example, handling encapsulation of data sent to or received from the secure resource. Computer networks employ a tunneling protocol to facilitate having one network protocol (e.g., the delivery protocol) encapsulate another protocol (e.g., payload protocol). Tunneling facilitates securely carrying a payload over an insecure network (e.g., Internet).

In different embodiments, some processing may be performed on the apparatus 500 and some processing may be performed by an external service or apparatus. Thus, in one embodiment, apparatus 500 may also include a communication circuit that is configured to communicate with an external source to facilitate identifying and using preferred protocols. In one embodiment, the apparatus 500 may interact with a presentation service 560 to facilitate displaying data using different presentations for different devices.

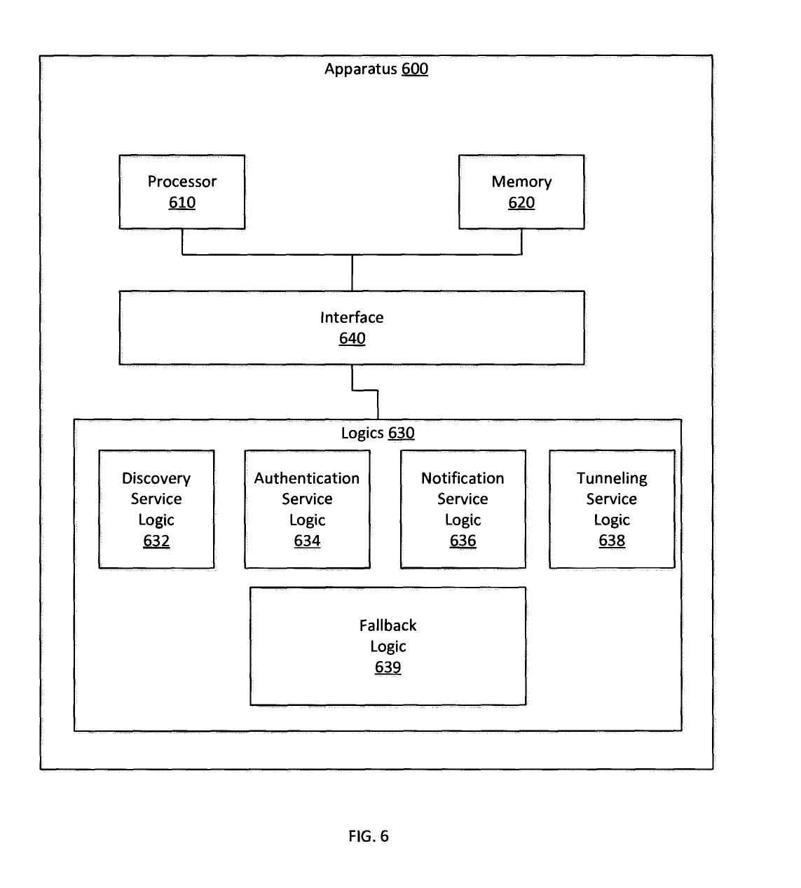

FIG. 6 illustrates an apparatus 600 that is similar to apparatus 500 (FIG. 5). For example, apparatus 600 includes a processor 610, a memory 620, a set 630 of logics (e.g., 632, 634, 636, 638) that correspond to the set 530 of logics (FIG. 5) and an interface 640. However, apparatus 600 includes an additional fallback logic 639. The fallback logic 639 may be configured to find a second set of protocols that are different from the preferred protocol configuration that failed to establish the desired secure connection. The second set of protocols may be found, for example, by cycling through a pre-configured or dynamically populated list of available protocols or combinations thereof. The fallback logic 639 may also be configured to establish the secure connection using the second set of protocols.

Once the secure connection has been established, the fallback logic 639 may then report the success of establishing the secure network connection using the second set of protocols. In one embodiment, reporting the success of establishing the secure network connection changes the likelihood that the notification service logic 536 will provide the second set of protocols as the preferred protocol configuration in response to receiving the network fingerprint data.

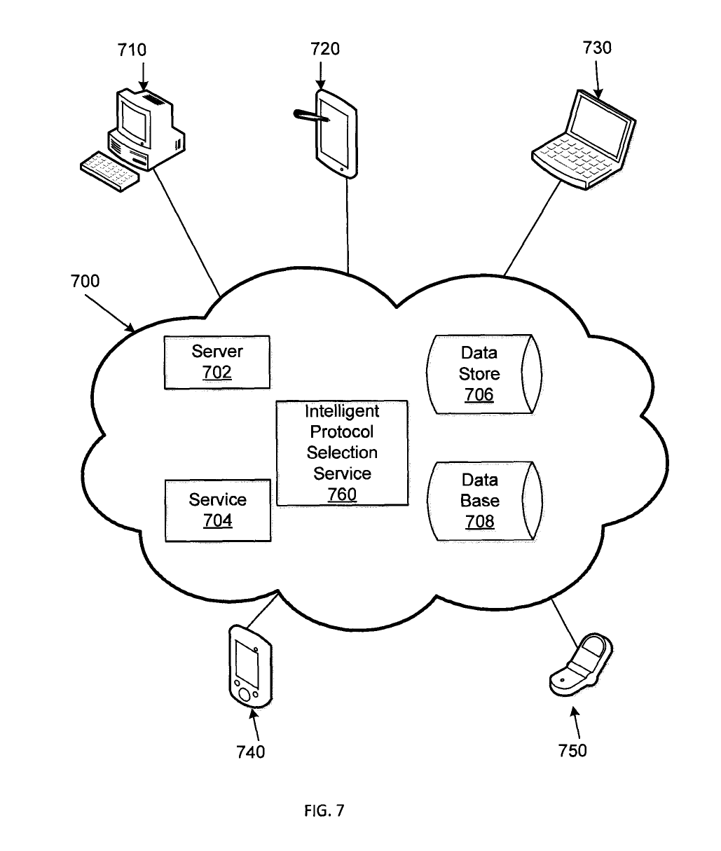

FIG. 7 illustrates an example cloud operating environment 700. A cloud operating environment 700 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 7 illustrates an example intelligent protocol selection service 760 residing in the cloud. The intelligent protocol selection service 760 may rely on a server 702 or service 704 to perform processing and may rely on a data store 706 or database 708 to store data. The stored data may include, for example, correlations or mappings between connection information and protocol information. While a single server 702, a single service 704, a single data store 706, and a single database 708 are illustrated, multiple instances of servers, services, data stores, and databases may reside in the cloud and may, therefore, be used by the intelligent protocol selection service 760.

FIG. 7 illustrates various devices accessing the intelligent protocol selection service 760 in the cloud. The devices include a computer 710, a tablet 720, a laptop computer 730, a personal digital assistant 740, and a mobile device (e.g., cellular phone, satellite phone, wearable computing device) 750. The intelligent protocol selection service 760 may produce a recommendation for a set of protocols to use to make a secure connection from a particular device through a particular access point at a particular location to a secure resource through a particular secure gateway. The intelligent protocol selection service 760 may maintain correlations or mappings between connection information and protocol information. Example mappings may be stored, for example, in database 708 where the connection information is used as a key and the protocol information is the value in a key:value pair. Example mappings may take forms including, but not limited to:

SSID:SourceNetworkIP:DestGWIP:AuthProto:TTL

SSID:SourceNetworkIP:DestGWIP:TunnelProto:TTL

SSID:SourceNetworkIP:DestGWIP:EncryptProto:TTL

CID:SourceNetworkIP:DestGWIP:AuthProto:TTL

CID:SourceNetworkIP:DestGWIP:TunnelProto:TTL

CID:SourceNetworkIP:DestGWIP:EncryptProto:TTL

where SSID represents a service set identifier,

where CID represents a cellular identifier,

where SourceNetworkIP represents an Internet Protocol address associated with a source network,

where DestGWIP represents an Internet Protocol address associated with a gateway protecting a secure resource,

where AuthProto represents an authentication protocol,

where TunnelProto represents a tunneling protocol,

where EncryptProto represents an encryption protocol, and

where TTL represents a time to live parameter.

Other mappings may be employed.

It is possible that different users at different locations using different devices may access the intelligent protocol selection service 760 through different networks or interfaces. In one example, the intelligent protocol selection service 760 may be accessed by mobile device 750. In another example, portions of intelligent protocol selection service 760 may reside on mobile device 750.

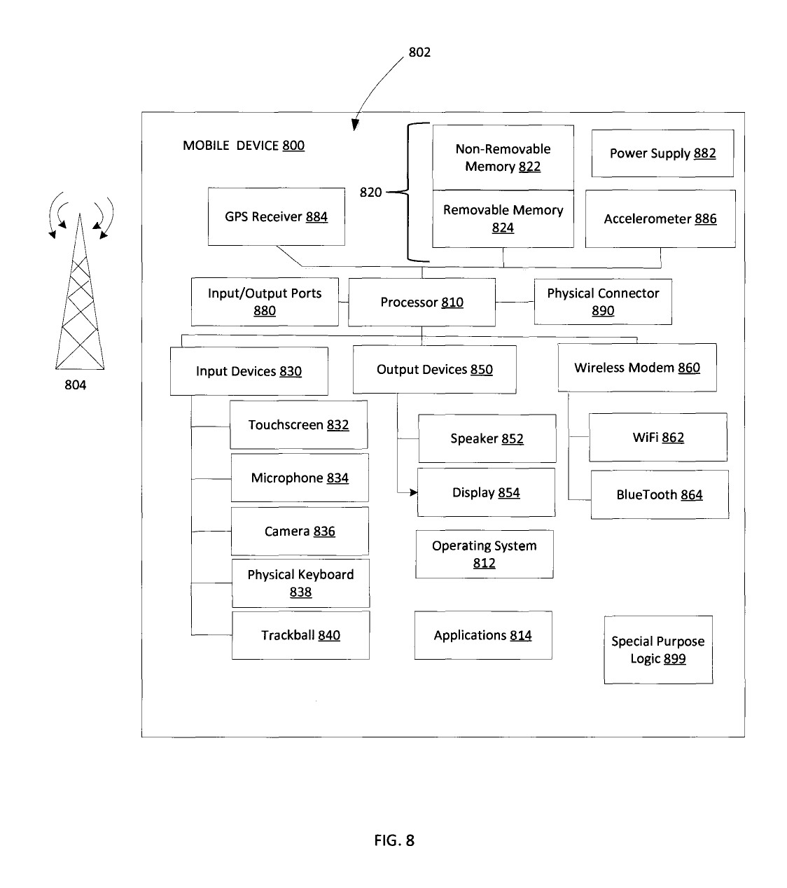

FIG. 8 is a system diagram depicting an exemplary mobile device 800 that includes a variety of optional hardware and software components, shown generally at 802. Components 802 in the mobile device 800 can communicate with other components, although not all connections are shown for ease of illustration. The mobile device 800 can be a variety of computing devices (e.g., cell phone, smartphone, handheld computer, Personal Digital Assistant (PDA), wearable computing devices, etc.) and can allow wireless two-way communications with one or more mobile communications networks 804, such as a cellular or satellite networks.

Mobile device 800 can include a controller or processor 810 (e.g., signal processor, microprocessor, ASIC, SoC, or other control and processing logic circuitry) for performing tasks including signal coding, data processing, input/output processing, power control, or other functions. An operating system 812 can control the allocation and usage of the components 802 and support application programs 814. The application programs 814 can include mobile computing applications (e.g., email applications, calendars, contact managers, web browsers, messaging applications), or other computing applications.

Mobile device 800 can include memory 820. Memory 820 can include non-removable memory 822 or removable memory 824. The non-removable memory 822 can include RAM, ROM, flash memory, a hard disk, or other memory storage technologies. The removable memory 824 can include flash memory or a Subscriber Identity Module (SIM) card, which is well known in GSM communication systems, or other memory storage technologies, such as “smart cards.” The memory 820 can be used for storing data or code for running the operating system 812 and the applications 814. Example data can include web pages, text, images, sound files, video data, or other data sets to be sent to or received from one or more network servers or other devices via one or more wired or wireless networks. The memory 820 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 800 can support one or more input devices 830 including, but not limited to, a touchscreen 832, a microphone 834, a camera 836, a physical keyboard 838, or trackball 840. The mobile device 800 may also support output devices 850 including, but not limited to, a speaker 852 and a display 854. Other possible output devices (not shown) can include piezoelectric or other haptic output devices. Some devices can serve more than one input/output function. For example, touchscreen 832 and display 854 can be combined in a single input/output device. The input devices 830 can include a Natural User Interface (NUI). An NUI is an interface technology that enables a user to interact with a device in a “natural” manner, free from artificial constraints imposed by input devices such as mice, keyboards, remote controls, and others. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 812 or applications 814 can comprise speech-recognition software as part of a voice user interface that allows a user to operate the device 800 via voice commands. Further, the device 800 can include input devices and software that allow for user interaction via a user's spatial gestures, such as detecting and interpreting gestures to provide input to a gaming application.

A wireless modem 860 can be coupled to an antenna 891. In some examples, RF filters are used and the processor 810 need not select an antenna configuration for a selected frequency band. The wireless modem 860 can support two-way communications between the processor 810 and external devices. The modem 860 is shown generically and can include a cellular modem for communicating with the mobile communication network 804 and/or other radio-based modems (e.g., Bluetooth 864 or Wi-Fi 862). The wireless modem 860 may be configured for communication with one or more cellular networks, such as a GSM network for data and voice communications within a single cellular network, between cellular networks, or between the mobile device and a public switched telephone network (PSTN).

The mobile device 800 may include at least one input/output port 880, a power supply 882, a satellite navigation system receiver 884, such as a Global Positioning System (GPS) receiver, an accelerometer 886, or a physical connector 890, which can be a USB port, IEEE 1394 (FireWire) port, RS-232 port, or other port. The illustrated components 802 are not required or all-inclusive, as other components can be deleted or added.

Mobile device 800 may include a special purpose logic 899 that is configured to provide a functionality for the mobile device 800. For example, logic 899 may provide a client for interacting with a service (e.g., service 760, FIG. 7).

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Data store”, as used herein, refers to a physical or logical entity that can store data. A data store may be, for example, a database, a table, a file, a list, a queue, a heap, a memory, a register, and other physical repository. In different examples, a data store may reside in one logical or physical entity or may be distributed between two or more logical or physical entities.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, a system-on-a-chip (SoC), and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one of, A, B, and C” is employed herein, (e.g., a data store configured to store one of, A, B, and C) it is intended to convey the set of possibilities A, B, and C, (e.g., the data store may store only A, only B, or only C). It is not intended to require one of A, one of B, and one of C. When the applicants intend to indicate “at least one of A, at least one of B, and at least one of C”, then the phrasing “at least one of A, at least one of B, and at least one of C” will be employed.

To the extent that the phrase “one or more of, A, B, and C” is employed herein, (e.g., a data store configured to store one or more of, A, B, and C) it is intended to convey the set of possibilities A, B, C, AB, AC, BC, ABC, AA . . . A, BB . . . B, CC . . . C, AA . . . ABB . . . B, AA . . . ACC . . . C, BB . . . BCC . . . C, or AA . . . ABB . . . BCC . . . C (e.g., the data store may store only A, only B, only C, A&B, A&C, B&C, A&B&C, or other combinations thereof including multiple instances of A, B, or C). It is not intended to require one of A, one of B, and one of C. When the applicants intend to indicate “at least one of A, at least one of B, and at least one of C”, then the phrasing “at least one of A, at least one of B, and at least one of C” will be employed.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
upon determining that a mobile device is seeking to make a connection to a secure resource from a location through a network:
acquiring identifying information associated with the mobile device, the location, or the secure resource;
upon determining that preferred connection information related to the identifying information is available to the mobile device:
controlling the mobile device to make the connection using the preferred connection information;
upon determining that the connection was made using the preferred connection information:
recording that the connection was made using the preferred connection information;
and
upon determining that preferred connection information related to the identifying information is not available to the mobile device:
controlling the mobile device to make the connection using a set of discovered protocol information; and
recording that the connection was made using the set of discovered protocol information.

2. The method of claim 1, comprising:
upon determining that the connection was not made using the preferred connection information:
recording that the connection was not made using the preferred connection information;
controlling the mobile device to make the connection using the set of discovered protocol information; and
recording that the connection was made using the set of discovered protocol information.

3. The method of claim 2, where the identifying information includes a service set identifier or a cellular identifier, a publicly routable address of the network through which the mobile device is seeking to make the connection, or a routable address of a secure gateway through which the secure resource is available.

4. The method of claim 2, where the preferred connection information includes authentication protocol information, encryption protocol information, or tunneling protocol information.

5. The method of claim 2, where determining that preferred connection information related to the identifying information is available to the mobile device includes accessing a data store on the mobile device or accessing a service located off the mobile device.

6. The method of claim 5, where determining that preferred connection information related to the identifying information is available to the mobile device includes determining that the preferred connection information has not exceeded a time to live threshold.

7. The method of claim 5, where recording that the connection was made using the preferred connection information includes updating the data store on the mobile device or updating the service located off the mobile device.

8. The method of claim 7, where updating the data store on the mobile device or updating the service located off the mobile device includes voting up a value associated with the preferred connection information, updating a success indicator associated with the preferred connection information, or updating a time to live value associated with the preferred connection information.

9. The method of claim 7, where recording that the connection was not made using the preferred connection information includes updating the data store on the mobile device or updating the service located off the mobile device.

10. The method of claim 9, where updating the data store on the mobile device or updating the service located off the mobile device includes voting down a value associated with the preferred connection information, or updating a failure indicator associated with the preferred connection information.

11. The method of claim 9, where recording that the connection was made using the set of discovered protocol information includes updating the data store on the mobile device with the set of discovered protocol information and the identifying information and relating the set of discovered protocol information to the identifying information, or updating the service located off the mobile device with the set of discovered protocol information and the identifying information and causing the service to relate the set of discovered protocol information to the identifying information.

12. The method of claim 1, comprising updating a data store on the mobile device with connection information received from a service external to the mobile device, where the connection information is received independent of an attempt by the mobile device to make a connection.

13. The method of claim 12, where the service is a public service, an enterprise service, or a private service.

14. A computer-readable medium storing computer-executable instructions that when executed by a computer control the computer to perform a method, the method comprising:
upon determining that a mobile device is seeking to make a connection to a secure resource from a location through a network:
acquiring identifying information associated with the mobile device, the location, or the secure resource, where the identifying information includes a service set identifier or a cellular identifier, a publicly routable address of the network, or a routable address of a secured gateway through which the secure resource is available;
determining whether preferred connection information related to the identifying information is available to the mobile device by accessing a data store on the mobile device or accessing a service located off the mobile device, where the preferred connection information includes authentication protocol information, encryption protocol information, or tunneling protocol information, and where determining that the preferred connection information related to the identifying information is available to the mobile device includes determining that the preferred connection information has not exceeded a time to live threshold,
upon determining that preferred connection information related to the identifying information is available to the mobile device:
controlling the mobile device to make the connection using the preferred connection information;
upon determining that the connection was made using the preferred connection information:
recording that the connection was made using the preferred connection information, updating the data store on the mobile device or updating the service located off the mobile device by voting up a value associated with the preferred connection information, updating a success indicator associated with the preferred connection information, or updating a time to live value associated with the preferred connection information;
upon determining that the connection was not made using the preferred connection information:
recording that the connection was not made using the preferred connection information, updating the data store on the mobile device or updating the service located off the mobile device by voting down a value associated with the preferred connection information, updating a failure indicator associated with the preferred connection information, or updating a time to live value associated with the preferred connection information;
controlling the mobile device to make the connection using a set of discovered protocol information; and
recording that the connection was made using the set of discovered protocol information,
upon determining that preferred connection information related to the identifying information is not available to the mobile device:
controlling the mobile device to make the connection using the set of discovered protocol information; and
recording that the connection was made using the set of discovered protocol information by updating the data store on the mobile device with the set of discovered protocol information and the identifying information and relating the set of discovered protocol information to the identifying information, or updating the service located off the mobile device with the set of discovered protocol information and the identifying information and causing the service to relate the set of discovered protocol information to the identifying information,
and
updating a data store on the mobile device with connection information received from a service external to the mobile device, where the connection information is received independent of an attempt by the mobile device to make a connection.

15. An apparatus, comprising:
a processor;
a memory configured to store network fingerprint data correlated to connection protocol data;
a set of logics configured to select a preferred protocol configuration for a location specific secure network connection between the apparatus and a secure resource using a network and to establish the secure network connection; and
an interface to connect the processor, the memory, and the set of logics;
the set of logics comprising:
a discovery service logic configured to maintain correlations between connection protocol data and network fingerprint data, where the connection protocol data includes authentication, encryption, or tunneling information, and where the network fingerprint data includes network identification information and network address information;
an authentication service logic configured to establish a first connection between the apparatus and the network, where the first connection is identified by a network fingerprint;
a notification service logic configured to selectively provide the preferred protocol configuration associated with the location specific secure network connection in response to receiving the network fingerprint; and
a tunneling service logic configured to establish and maintain the location specific secure network connection using the preferred protocol configuration.

16. The apparatus of claim 15, the discovery service logic being configured:
to maintain correlations between connection protocol data and network fingerprint data by requesting updated correlations from a service external to the apparatus or by receiving updated correlations from the service, and
to selectively remove a correlation between a member of the connection protocol data and a member of the network fingerprint data upon determining that the correlation has exceeded a time to live threshold.

17. The apparatus of claim 16, the authentication service logic being configured to provide the network fingerprint associated with the first connection to the notification service logic, the network fingerprint comprising a network name or identifier, an Internet Protocol address for an access point through which the mobile device accessed the network, and an Internet Protocol address for the secure gateway.

18. The apparatus of claim 17, the notification service logic being configured to provide the preferred protocol configuration from the memory or from data provided by the service external to the apparatus.

19. The apparatus of claim 18, the notification service logic being configured to report the success or failure of establishing the location specific secure network connection using the preferred protocol configuration, where reporting the success or failure of establishing the location specific secure network connection will change the likelihood that the notification service logic will provide the preferred protocol configuration in response to receiving the network fingerprint data.

20. The apparatus of claim 15, the set of logics including a fallback logic configured:
to find a second set of protocols different from the preferred protocol configuration;
to establish the location specific secure connection using the second set of protocols, and
to report the success of establishing the location specific secure network connection using the second set of protocols, where reporting the success of establishing the secure network connection using the second set of protocols changes the likelihood that the notification service logic will provide the second set of protocols as the preferred protocol configuration in response to receiving the network fingerprint data.
